(19) United States
(12) Patent Application Publication
(10) Pub. No.: US 2015/0379268 A1
(43) Pub. Date: Dec. 31, 2015

(54) SYSTEM AND METHOD FOR THE TRACING AND DETECTION OF MALWARE

(71) Applicants: Prabhat Singh, New Thippasandra (IN); Zhixiong Wu, Santa Clara, CA (US)

(72) Inventors: Prabhat Singh, New Thippasandra (IN); Zhixiong Wu, Santa Clara, CA (US)

(21) Appl. No.: 14/318,262

(22) Filed: Jun. 27, 2014

(51) Int. Cl. G06F 21/56; G06F 21/55

(52) U.S. Cl. CPC G06F 21/566; G06F 21/554

(57) ABSTRACT

Particular embodiments described herein provide for an electronic device that can be configured to determine that a program related to a process begins to run, trace events related to the program when it is determined that the program should be monitored, and determine a number of events to be traced before the trace is concluded. The number of events to be traced can be related to the type of program. In addition, the number of events that are traced can be related to the activity of the program. A number of child events to be traced can be determined if the program has a child program. The traced child events can be combined with the events traced and the results can be analyzed to determining if the process includes malware.

### TECHNICAL FIELD

This disclosure relates in general to the field of information security, and more particularly, to the tracing and detection of malware.

### BACKGROUND

The field of network security has become increasingly important in today's society. The Internet has enabled interconnection of different computer networks all over the world. In particular, the Internet provides a medium for exchanging data between different users connected to different computer networks via various types of client devices. While the use of the Internet has transformed business and personal communications, it has also been used as a vehicle for malicious operators to gain unauthorized access to computers and computer networks and for intentional or inadvertent disclosure of sensitive information.

Malicious software (“malware”) that infects a host computer may be able to perform any number of malicious actions, such as stealing sensitive information from a business or individual associated with the host computer, propagating to other host computers, and/or assisting with distributed denial of service attacks, sending out spam or malicious emails from the host computer, etc. Hence, significant administrative challenges remain for protecting computers and computer networks from malicious and inadvertent exploitation by malicious software.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for mitigation of malware in a network environment in accordance with an embodiment of the present disclosure;

FIG. 2 is a simplified flowchart illustrating potential operations that may be associated with the communication system in accordance with an embodiment;

FIG. 3 is a simplified flowchart illustrating potential operations that may be associated with the communication system in accordance with an embodiment;

FIG. 4 is a simplified flowchart illustrating potential operations that may be associated with the communication system in accordance with an embodiment;

FIG. 5 is a simplified flowchart illustrating potential operations that may be associated with the communication system in accordance with an embodiment;

FIGS. 6 is a simplified flowchart illustrating potential operations that may be associated with the communication system in accordance with an embodiment;

FIG. 7 is a block diagram illustrating an example computing system that is arranged in a point-to-point configuration in accordance with an embodiment;

FIG. 8 is a simplified block diagram associated with an example ARM ecosystem system on chip (SOC) of the present disclosure; and

FIG. 9 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Example Embodiments

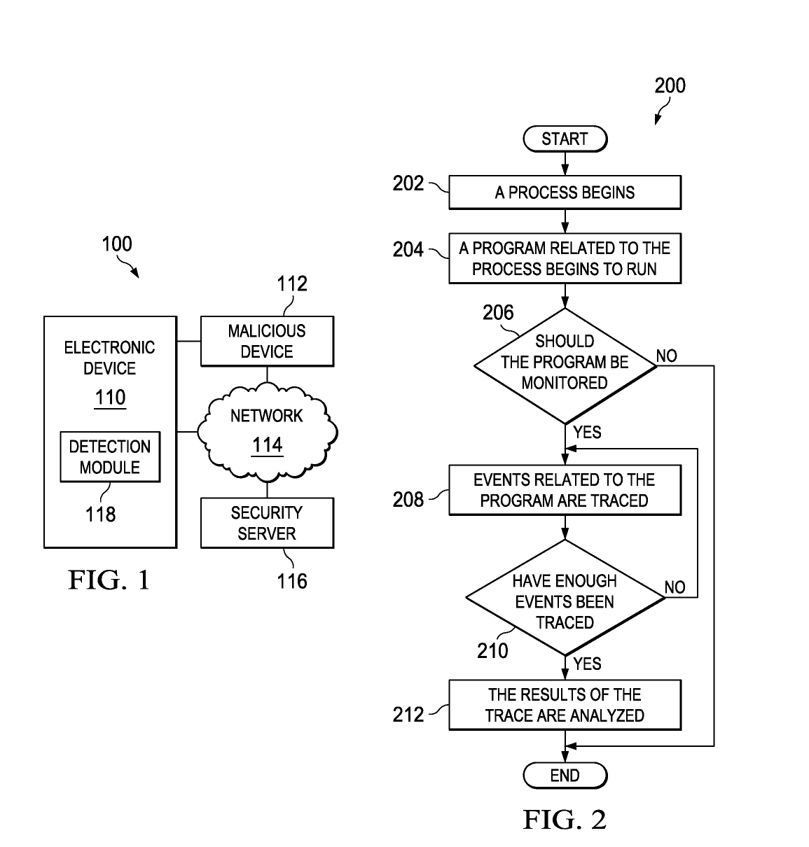

FIG. 1 is a simplified block diagram of a communication system 100 to help trace and detect malware. Communication system 100 can include an electronic device 110, a network 114, and a security server 116. Electronic device can include a detection module 118. A malicious device 112 may attempt to introduce malware to electronic device 110. Electronic device 110, malicious device 112, and security server 116 can be connected through network 114. In one example, malicious device 112 may be connected directly to electronic device 110 (e.g., through a Universal Serial Bus (USB) type connection).

In example embodiments, communication system 100 can be configured to determine that a program related to a characteristic begins to run, trace events related to the program when it is determined that the program should be monitored, and determine a number of events that are traced before the trace is concluded. The characteristic can be any characteristic that could indicate the program is malware or might contain malware. For example, the program might have a characteristic that allows the program to infiltrate, modify, change, corrupt, or damage a computer system without the owner's informed consent. The number of events to be traced can be related to the type of program. In addition, the number of events that are traced can be related to the activity of the program. Communication system 100 can further be configured to determine a number of child events to be traced if the program has a child program. A child of a program is any program or code that acts on behalf or in response to a request, event, or action from another program. Communication system 100 can be configured to consolidate traced events across a parent/child processes and analyze the results of the traced events to determining if the process includes malware. In other example, communication system 100 can be configured to analyze the results of the traced events and send the results to a security server. In some examples, the results of the traced events are normalized and consolidated before they are sent to the security server.

Elements of FIG. 1 may be coupled to one another through one or more interfaces employing any suitable connections (wired or wireless), which provide viable pathways for network (e.g., network 114) communications. Additionally, any one or more of these elements of FIG. 1 may be combined or removed from the architecture based on particular configuration needs. Communication system 100 may include a configuration capable of transmission control protocol/Internet protocol (TCP/IP) communications for the transmission or reception of packets in a network. Communication system 100 may also operate in conjunction with a user datagram protocol/IP (UDP/IP) or any other suitable protocol where appropriate and based on particular needs.

For purposes of illustrating certain example techniques of communication system 100, it is important to understand the communications that may be traversing the network environment. The following foundational information may be viewed as a basis from which the present disclosure may be properly explained.

Increased access to the Internet has had the unintended effect of increasing the reach of software programs that capture personal information of users without their informed consent or that corrupt computers without the user's knowledge and informed consent. The term malware as used herein includes any type of software programs designed to infiltrate, modify, change, corrupt, or damage a computer system without the owner's informed consent, regardless of the motivation for the software program, and regardless of the results caused by the software program on the owner's devices, systems, networks, or data.

Various detection programs may be used to attempt to detect the presence of malware. In some instances, the detection programs rely on detecting a signature in a software program being examined to determine if the program is or contains malware. In some instances, the detection program uses a tracing method to determine whether a software program is malware. However, malware authors frequently change or alter parts of the malware programs in order to avoid detection by tracing methods.

As a result, antimalware vendors and security systems have adopted behavioral techniques to aim for proactive detections. However, some techniques are single process oriented and are not effective on multi-component threats. Some threats tend to have several components. For example, some threats start with a malicious URL, exploiting a vulnerability or hosting a drive-by download. Then a malicious download from the malicious uniform resource locator (URL) (e.g., a C&C bot code, password stealer payload, etc.) is likely to be spawned as a separate processes. Tracing a single process does not build the context throughout the end to end threat event, thus limiting the protection value.

In addition, when tracing threat activities, some techniques use a hard coded or preconfigured timeout to determine when to stop tracing. This is not effective because each threat has different infection time window and it is not guaranteed that 30 or 60 seconds of tracing can capture sufficient events or behaviors for malware detection. Threats may be waiting for activities on user machines, handshakes and commands from malware server, etc., to proceed and 60 seconds of tracing is not likely to identify the malicious activity.

A communication system for tracing and detecting malware, as outlined in FIG. 1, can resolve these issues (and others). In communication system 100 of FIG. 1, to trace and detect malware, the system may be configured to group events or behaviors of files and programs after the events are normalized and consolidated. This can build a generic but detailed enough end to end threat event trace. The consolidated events are tagged and correlated using rules and machine learning so that a mitigation policy can be applied accordingly to each component when a threat is detected. The terms “event” and “events” as used throughout is to include behaviors, actions, calls, re-directs, downloads, or any other process, event, or behavior malicious code may use against an electronic device.

In addition, detection module 118 can us an intelligence context for determining the tracing duration. Instead of a hardcoded timeout, detection module 118 can utilize contextual triggers to determine when tracing is sufficient and when it should be suspended and resumed.

Communication system 100 can be configured to monitor events across multiple processes and consolidate the events into a single trace. Current solutions do not integrate the events across multiple processes into a consolidated trace. To avoid detection, some malware has shifted to be either multi-components or have inter-dependent payloads among their allies. Events from a single process or single component oftentimes do not present sufficient suspicious activity. Detection module 118 can be configured to build an event trace with context across processes and combine the events throughout the related components. Consolidating the events of multiple processes can also help with machine learning and classification of malware.

In a specific example, a trace of malware events (e.g., a malware spawning tree) can have multiple branches. Process A may spawn process B1 and B2; and B1 may spawn C1, C2, C3; and so on. These activities are consolidated to describe the complete threat and help detect the malware. The events can also be tagged for correlation in a classification phase. The classification phase can help prevent potential false positives because some of the processes in a trace of the malware events can be benign and may need to be ignored during mitigation.

Tracing completion can be determined contextually and is based on event correlation and other triggering conditions of tracing suspension and resume. For example, in a low activity event trace, the tracing can be suspended until a send/receive data event from a port triggers a resumption of the tracing. If a security system was hardcoded or pre-configured for a 30 seconds or 60 seconds timeout to conclude the tracing, then the security system could miss the send/receive data event and not detect the malware. In another example, a volume of certain events within a unit time range can help determine when to conclude tracing.

Turning to the infrastructure of FIG. 1, communication system 100 in accordance with an example embodiment is shown. Generally, communication system 100 can be implemented in any type or topology of networks. Network 114 represents a series of points or nodes of interconnected communication paths for receiving and transmitting packets of information that propagate through communication system 100. Network 114 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In communication system 100, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications over a cellular network may also be provided in communication system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, electronic device 110 and security server 116 are network elements, which are meant to encompass network appliances, servers, routers, switches, gateways, bridges, load balancers, processors, modules, or any other suitable device, component, element, or object operable to exchange information in a network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with communication system 100, each of electronic device 110 and security server 116 can include memory elements for storing information to be used in the operations outlined herein. Each of electronic device 110 and security server 116 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication system 100, such as electronic device 110 and security server 116 may include software modules (e.g., detection module 118) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of electronic device 110 and security server 116 may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Electronic device 110 can be a network element and includes, for example, desktop computers, laptop computers, mobile devices, personal digital assistants, smartphones, tablets, or other similar devices. Security server 116 can be a network element such as a server or virtual server and can be associated with clients, customers, endpoints, or end users wishing to initiate a communication in communication system 100 via some network (e.g., network 114). The term ‘server’ is inclusive of devices used to serve the requests of clients and/or perform some computational task on behalf of clients within communication system 100. Although detection module 110 is represented in FIG. 1 as being located in electronic device 110, this is for illustrative purposes only. Detection module 118 could be combined or separated in any suitable configuration. Furthermore, detection module 118 could be integrated with or distributed in security server 116, a cloud services or in another network accessible by electronic device 102. Cloud services may generally be defined as the use of computing resources that are delivered as a service over a network, such as the Internet. Typically, compute, storage, and network resources are offered in a cloud infrastructure, effectively shifting the workload from a local network to the cloud network

Turning to FIG. 2, FIG. 2 is an example flowchart illustrating possible operations of a flow 200 that may be associated with tracing and detection of malware, in accordance with an embodiment. In an embodiment, one or more operations of flow 200 may be performed by detection module 118. At 202, a process begins. At 204, a program related to the process begins to run. At 206, they system determines if the program should be monitored. If the program should not be monitored, then the flow stops. If the program should be monitored, then events related to the program are traced, as in 208. At 210, the system determines if enough events have been traced to determine if the file is malware. If enough events have not been traced, or if more events need to be traced, then the system returns to 208 and events related to the program are traced. If enough events have been traced, then the results of the trace are analyzed, as in 212.

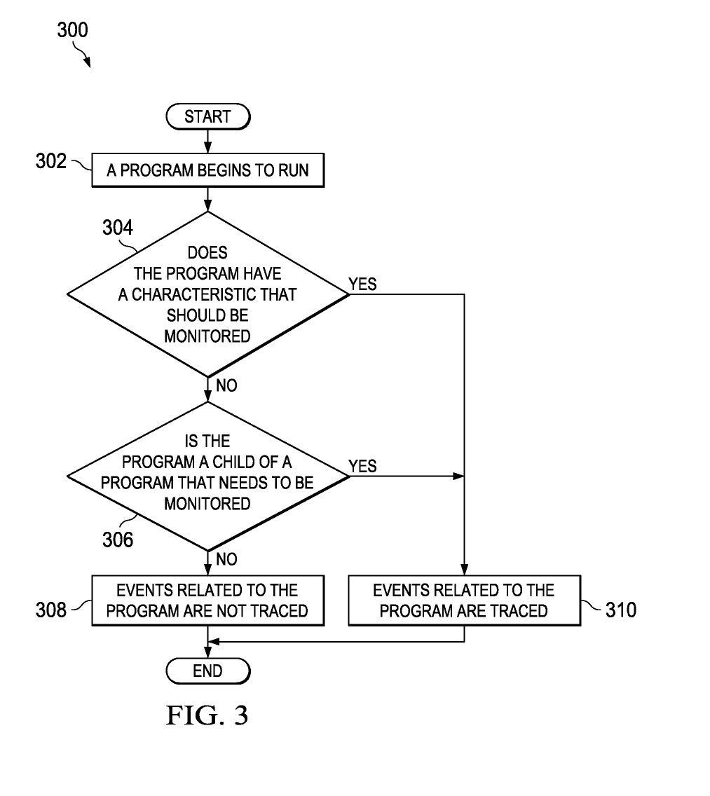

Turning to FIG. 3, FIG. 3 is an example flowchart illustrating possible operations of a flow 300 that may be associated with tracing and detecting malware, in accordance with an embodiment. In an embodiment, one or more operations of flow 300 may be performed by detection module 118. At 302, a program begins to run. At 304, the system determines if the program has a characteristic that should be monitored. If the program has a characteristic or process that should be monitored, then events related to the program are traced, as in 310. If the program does not have a characteristic or process that should be monitored, then the system determines if the program is a child of a program that needs to be monitored, as in 306. A child of a program is any program or code that acts on behalf or in response to a request, event, or action from another program. If the program is a child of a program that needs to be monitored, then then events related to the (child) program are traced, as in 310. If the program is not a child of a program that needs to be monitored, then events related to the program (including the child program) are not traced, as in 308.

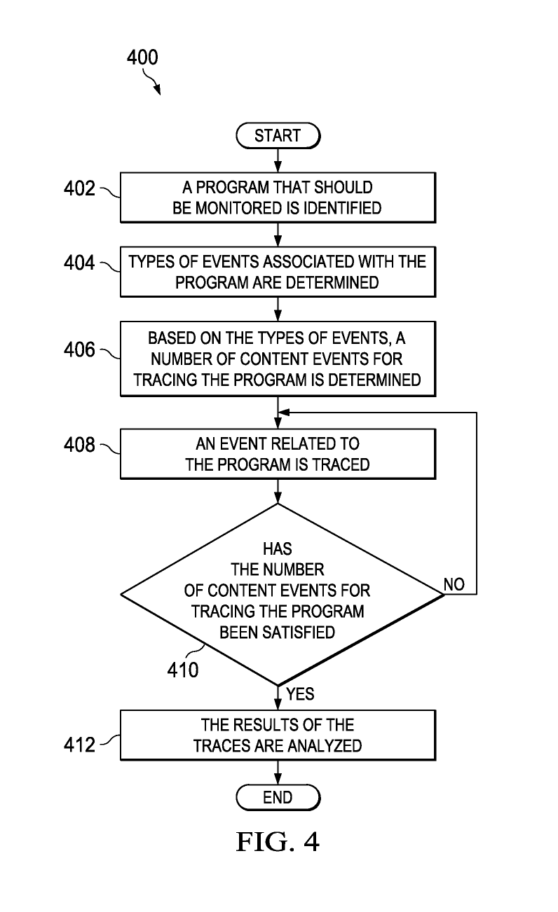

Turning to FIG. 4, FIG. 4 is an example flowchart illustrating possible operations of a flow 400 that may be associated with tracing and detecting malware, in accordance with an embodiment. In an embodiment, one or more operations of flow 400 may be performed by detection module 118. At 402, a program that should be monitored is identified. At 404, types of events associated with the program are determined. At 406, based on the types of events, a number of content events for tracing the program is determined. Because the system is interested in monitoring events that could indicate the presence of malware, content events (e.g., quality events or those events that could indicate the presence of malware) are traced and not just a number of events that may or may not indicate the presence of malware. At 408, an event related to the program is traced. At 410, the system determines if the number of content events for tracing the program has been satisfied. If the number of events for tracing the program has not been satisfied, then an event (a new event) related to the program is traced, as in 408. If the number of events for tracing the program has been satisfied, then the results of the traces are analyzed, as in 412.

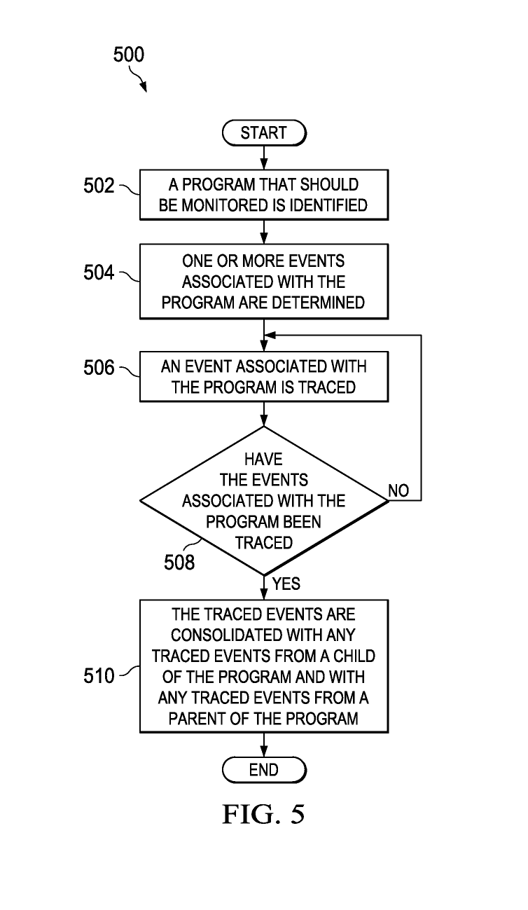

Turning to FIG. 5, FIG. 5 is an example flowchart illustrating possible operations of a flow 500 that may be associated with tracing and detecting malware, in accordance with an embodiment. In an embodiment, one or more operations of flow 300 may be performed by detection module 118. At 502, a program that should be monitored is identified. At 504, one or more events associated with the program are determined. At 506, an event associated with the program is traced. At 508, the system determines if the one or more events associated with the program have been traced. If the events associated with the program have not been traced, then an event (a new event) associated with the program is traced, as in 506. If the events associated with the program have been traced, then the traced events are consolidated with any traced events for a child of the program and with any traced events from a parent of the program, as in 510.

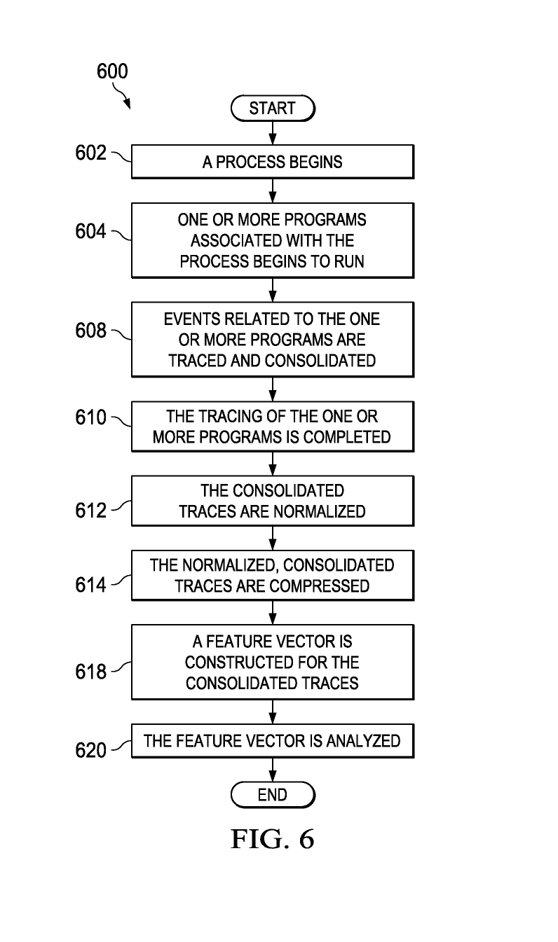

Turning to FIG. 6, FIG. 6 is an example flowchart illustrating possible operations of a flow 600 that may be associated with tracing and detecting malware, in accordance with an embodiment. In an embodiment, one or more operations of flow 300 may be performed by detection module 118. At 602, a process begins. At 604, one or more programs associated with the process begins to run. At 608, events related to the one or more programs are traced and consolidated. At 610, the tracing of the one or more programs is completed. By completing the tracing, system resources can be freed up for use by other processes. At 612, the consolidated traces are normalized. At 614, the normalized, consolidated traces are compressed. At 618, a feature vector is constructed for the consolidated traces. The feature vector can include a fixed-size list of attributes about the traces). At 620, the feature vector is analyzed. In some example implementations, the consolidated traces are not compressed and a feature vector is not constructed.

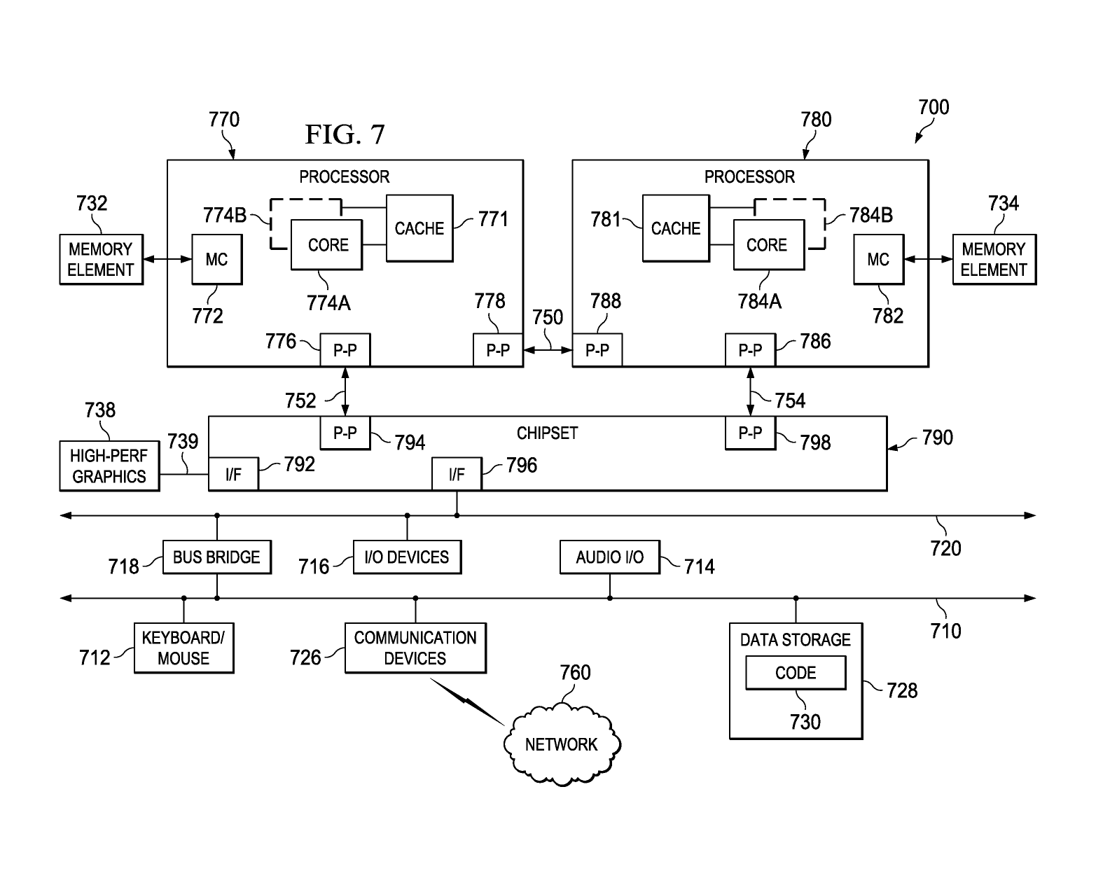

FIG. 7 illustrates a computing system 700 that is arranged in a point-to-point (PtP) configuration according to an embodiment. In particular, FIG. 7 shows a system where processors, memory, and input/output devices are interconnected by a number of point-to-point interfaces. Generally, one or more of the network elements of communication system 100 may be configured in the same or similar manner as computing system 700.

As illustrated in FIG. 7, system 700 may include several processors, of which only two, processors 770 and 780, are shown for clarity. While two processors 770 and 780 are shown, it is to be understood that an embodiment of system 700 may also include only one such processor. Processors 770 and 780 may each include a set of cores (i.e., processor cores 774A and 774B and processor cores 784A and 784B) to execute multiple threads of a program. The cores may be configured to execute instruction code in a manner similar to that discussed above with reference to FIGS. 1-4. Each processor 770, 780 may include at least one shared cache 771, 781. Shared caches 771, 781 may store data (e.g., instructions) that are utilized by one or more components of processors 770, 780, such as processor cores 774 and 784.

Processors 770 and 780 may also each include integrated memory controller logic (MC) 772 and 782 to communicate with memory elements 732 and 734. Memory elements 732 and/or 734 may store various data used by processors 770 and 780. In alternative embodiments, memory controller logic 772 and 782 may be discrete logic separate from processors 770 and 780.

Processors 770 and 780 may be any type of processor and may exchange data via a point-to-point (PtP) interface 750 using point-to-point interface circuits 778 and 788, respectively. Processors 770 and 780 may each exchange data with a chipset 790 via individual point-to-point interfaces 752 and 754 using point-to-point interface circuits 776, 786, 794, and 798. Chipset 790 may also exchange data with a high-performance graphics circuit 738 via a high-performance graphics interface 739, using an interface circuit 792, which could be a PtP interface circuit. In alternative embodiments, any or all of the PtP links illustrated in FIG. 7 could be implemented as a multi-drop bus rather than a PtP link.

Chipset 790 may be in communication with a bus 720 via an interface circuit 796. Bus 720 may have one or more devices that communicate over it, such as a bus bridge 718 and I/O devices 716. Via a bus 710, bus bridge 718 may be in communication with other devices such as a keyboard/mouse 712 (or other input devices such as a touch screen, trackball, etc.), communication devices 726 (such as modems, network interface devices, or other types of communication devices that may communicate through a computer network 760), audio I/O devices 714, and/or a data storage device 728. Data storage device 728 may store code 730, which may be executed by processors 770 and/or 780. In alternative embodiments, any portions of the bus architectures could be implemented with one or more PtP links.

The computer system depicted in FIG. 7 is a schematic illustration of an embodiment of a computing system that may be utilized to implement various embodiments discussed herein. It will be appreciated that various components of the system depicted in FIG. 7 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

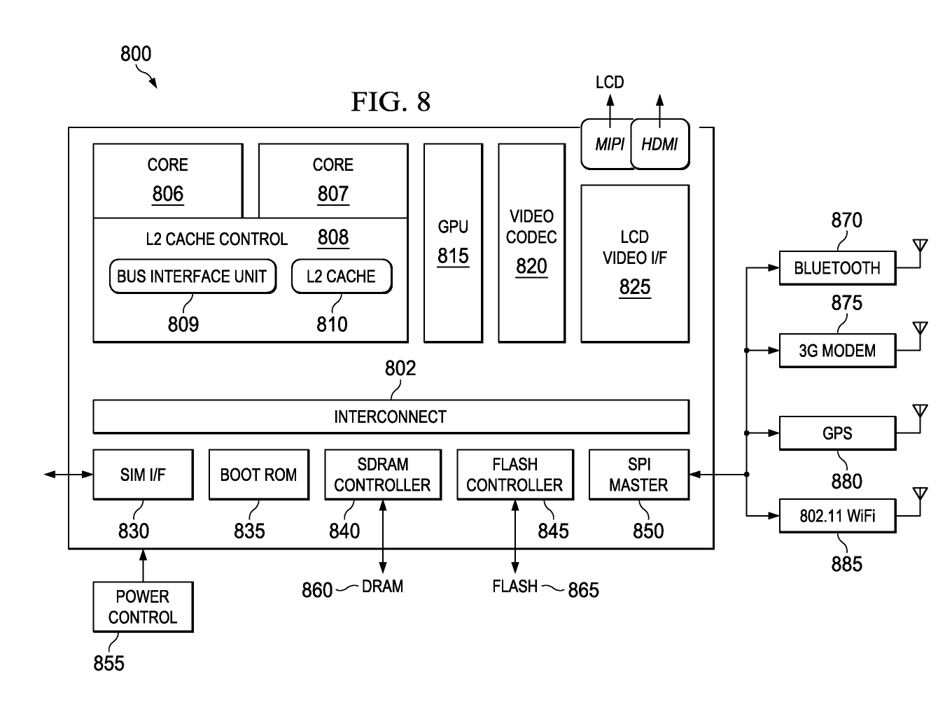

Turning to FIG. 8, FIG. 8 is a simplified block diagram associated with an example ARM ecosystem SOC 800 of the present disclosure. At least one example implementation of the present disclosure can include the tracing and detection features discussed herein and an ARM component. For example, the example of FIG. 8 can be associated with any ARM core (e.g., A-9, A-15, etc.). Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 8, ARM ecosystem SOC 800 may include multiple cores 806-807, an L2 cache control 808, a bus interface unit 809, an L2 cache 810, a graphics processing unit (GPU) 815, an interconnect 802, a video codec 820, and a liquid crystal display (LCD) I/F 825, which may be associated with mobile industry processor interface (MIPI)/high-definition multimedia interface (HDMI) links that couple to an LCD.

ARM ecosystem SOC 800 may also include a subscriber identity module (SIM) I/F 830, a boot read-only memory (ROM) 835, a synchronous dynamic random access memory (SDRAM) controller 840, a flash controller 845, a serial peripheral interface (SPI) master 850, a suitable power control 855, a dynamic RAM (DRAM) 860, and flash 865. In addition, one or more example embodiments include one or more communication capabilities, interfaces, and features such as instances of Bluetooth™ 870, a 3G modem 875, a global positioning system (GPS) 880, and an 802.11 Wi-Fi 885.

In operation, the example of FIG. 8 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

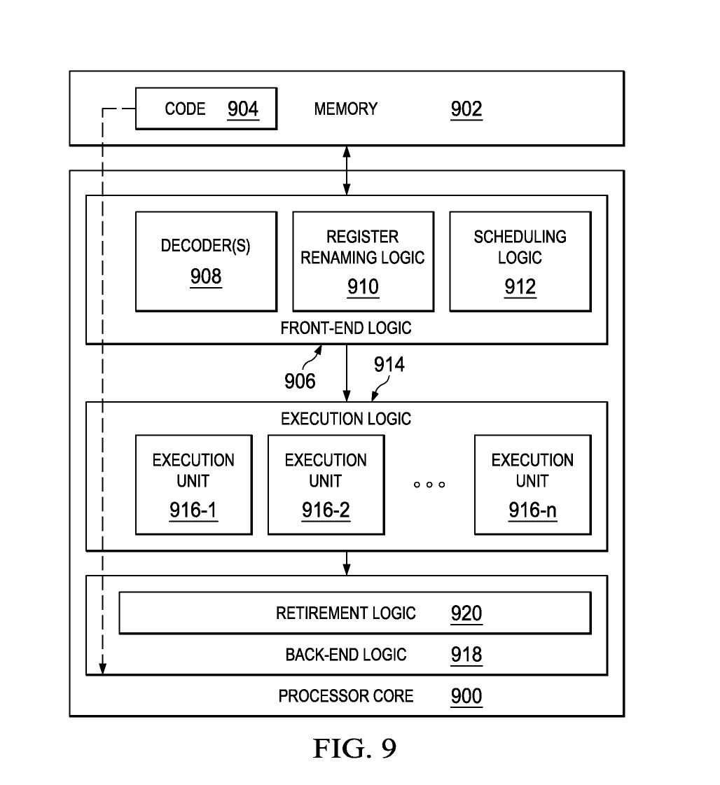

FIG. 9 illustrates a processor core 900 according to an embodiment. Processor core 900 may be the core for any type of processor, such as a micro-processor, an embedded processor, a digital signal processor (DSP), a network processor, or other device to execute code. Although only one processor core 900 is illustrated in FIG. 9, a processor may alternatively include more than one of the processor core 900 illustrated in FIG. 9. For example, processor core 900 represents one example embodiment of processors cores 774a, 774b, 784a, and 784b shown and described with reference to processors 770 and 780 of FIG. 7. Processor core 900 may be a single-threaded core or, for at least one embodiment, processor core 900 may be multithreaded in that it may include more than one hardware thread context (or “logical processor”) per core.

FIG. 9 also illustrates a memory 902 coupled to processor core 900 in accordance with an embodiment. Memory 902 may be any of a wide variety of memories (including various layers of memory hierarchy) as are known or otherwise available to those of skill in the art. Memory 902 may include code 904, which may be one or more instructions, to be executed by processor core 900. Processor core 900 can follow a program sequence of instructions indicated by code 904. Each instruction enters a front-end logic 906 and is processed by one or more decoders 908. The decoder may generate, as its output, a micro operation such as a fixed width micro operation in a predefined format, or may generate other instructions, microinstructions, or control signals that reflect the original code instruction. Front-end logic 906 also includes register renaming logic 910 and scheduling logic 912, which generally allocate resources and queue the operation corresponding to the instruction for execution.

Processor core 900 can also include execution logic 914 having a set of execution units 916-1 through 916-N. Some embodiments may include a number of execution units dedicated to specific functions or sets of functions. Other embodiments may include only one execution unit or one execution unit that can perform a particular function. Execution logic 914 performs the operations specified by code instructions.

After completion of execution of the operations specified by the code instructions, back-end logic 918 can retire the instructions of code 904. In one embodiment, processor core 900 allows out of order execution but requires in order retirement of instructions. Retirement logic 920 may take a variety of known forms (e.g., re-order buffers or the like). In this manner, processor core 900 is transformed during execution of code 904, at least in terms of the output generated by the decoder, hardware registers and tables utilized by register renaming logic 910, and any registers (not shown) modified by execution logic 914.

Although not illustrated in FIG. 9, a processor may include other elements on a chip with processor core 900, at least some of which were shown and described herein with reference to FIG. 7. For example, as shown in FIG. 7, a processor may include memory control logic along with processor core 900. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 and its teachings are readily scalable and can accommodate a large number of components, as well as more complicated/sophisticated arrangements and configurations. Accordingly, the examples provided should not limit the scope or inhibit the broad teachings of communication system 100 as potentially applied to a myriad of other architectures.

It is also important to note that the operations in the preceding flow diagrams (i.e., FIGS. 2-6) illustrate only some of the possible correlating scenarios and patterns that may be executed by, or within, communication system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 100 has been illustrated with reference to particular elements and operations that facilitate the communication process, these elements and operations may be replaced by any suitable architecture, protocols, and/or processes that achieve the intended functionality of communication system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Other Notes and Examples

Example C1 is at least one machine readable storage medium having one or more instructions that when executed by a processor cause the processor to determine that a program related to a process begins to run, trace events related to the program when it is determined that the program should be monitored, determine a number of events to be traced before the trace is concluded, and analyze the results of the traced events to determining if the process includes malware.

In Example C2, the subject matter of Example C1 can optionally include where the number of events to be traced is related to the type of program.

In Example C3, the subject matter of any one of Examples C1-C2 can optionally include where the number of events that are traced is related to the activity of the program.

In Example C4, the subject matter of any one of Examples C1-C3 can optionally include where the instructions, when executed by the processor, further cause the processor to determine if the program has a child program.

In Example C5, the subject matter of any one of Examples C1-C4 can optionally include where the instructions, when executed by the processor, further cause the processor to determine a number of child events to be traced if the program has a child program.

In Example C6, the subject matter of any one of Example C1-C5 can optionally include where the instructions, when executed by the processor, further cause the processor to combine the traced child events with the events traced.

In Example C7, the subject matter of any one of Examples C1-C6 can optionally include where the instructions, when executed by the processor, further cause the processor to analyze the results of the traced events to determining if the process includes malware.

In Example C8, the subject matter of any one of Examples C1-C7 can optionally include where the instructions, when executed by the processor, further cause the processor to communicate the results of the trace to a network element for further analysis.

In Example A1, an apparatus can include a detection module, wherein the detection module is configured to determine that a program related to a process begins to run, trace events related to the program when it is determined that the program should be monitored, determine a number of events to be traced before the trace is concluded, and analyze the results of the traced events to determining if the process includes malware.

In Example, A2, the subject matter of Example A1 can optionally include where the number of events to be traced is related to the type of program.

In Example A3, the subject matter of any one of Examples A1-A2 can optionally include where the detection module is further configured to determine if the program has a child program.

In Example A4, the subject matter of any one of Examples A1-A3 can optionally include where the detection module is further configured to determine a number of child events to be traced if the program has a child program.

In Example A5, the subject matter of any one of Examples A1-A4 can optionally include where the detection module is further configured to combine the traced child events with the events traced.

In Example A6, the subject matter of any one of Examples A1-A5 can optionally include where the number of events to be traced is based on contextual triggers.

In Example A7, the subject matter of any one of Examples A1-A6 can optionally include where the results of the trace are communicated to a network element for further analysis.

Example M1 is a method including determining that a program related to a process has begun to run, tracing events related to the program when it is determined that the program should be monitored, determining a number of events to be traced before the trace is concluded, and analyzing the results of the traced events to determining if the process includes malware.

In Example M2, the subject matter of Example M1 can optionally include where the number of events to be traced is related to the type of program.

In Example M3, the subject matter of any one of the Examples M1-M2 can optionally include determining if the program has a child program.

In Example M4, the subject matter of any one of the Examples M1-M3 can optionally include determining a number of child events to be traced if the program has a child program.

In Example M5, the subject matter of any one of the Examples M1-M4 can optionally include combining the traced child events with the events traced.

In Example M6, the subject matter of any one of the Examples M1-M5 can optionally include analyzing the results of the traced events and sending the results to a security server.

In Example M7, the subject matter of any one of the Examples M1-M6 can optionally include where the number of events to be traced is based on contextual triggers.

Example S1 is a system for the tracing and detection of malware, the system including a detection module configured to determine that a program related to a process begins to run, trace events related to the program when it is determined that the program should be monitored, determine a number of events to be traced before the trace is concluded, where the number of events to be traced is related to the type of program, combine the traced events with events from other programs related to the process, and analyze the results of the combined traced events and the events from other programs to determining if the process includes malware.

In Example S2, the subject matter of Example S1 can optionally include where the number of events to be traced is based on contextual triggers.

In Example S3, the subject matter of any of the Examples S1-S2 can optionally include the detection module being further configured to determine if the program has a child program, determine a number of child events to be traced if the program has a child program, combine the traced child events with the events traced, and analyze the results of the traced events to determining if the process includes malware

Example X1 is a machine-readable storage medium including machine-readable instructions to implement a method or realize an apparatus as in any one of the Examples A1-A7, or M1-M7. Example Y1 is an apparatus comprising means for performing of any of the Example methods M1-M7. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one computer-readable medium comprising one or more instructions that when executed by a processor, cause the processor to:
determine that a program related to a process begins to run;
trace events related to the program when it is determined that the program should be monitored;
determine a number of events to be traced before the trace is concluded; and
analyze the results of the traced events to determining if the process includes malware.

2. The at least one computer-readable medium of claim 1, wherein the number of events to be traced is related to the type of program.

3. The at least one computer-readable medium of claim 1, wherein the number of events that are traced is related to the activity of the program.

4. The at least one computer-readable medium of claim 1, further comprising one or more instructions that when executed by the processor:
determine if the program has a child program.

5. The at least one computer-readable medium of claim 4, further comprising one or more instructions that when executed by the processor:
determine a number of child events to be traced if the program has the child program.

6. The at least one computer-readable medium of claim 5, further comprising one or more instructions that when executed by the processor:
combine the traced child events with the events traced.

7. The at least one computer-readable medium of claim 1, wherein the number of events to be traced is based on contextual triggers.

8. The at least one computer-readable medium of claim 7, further comprising one or more instructions that when executed by the processor:
communicate the results of the trace to a network element for further analysis.

9. An apparatus comprising:
a detection module, wherein the detection module is configured to:
determine that a program related to a process begins to run;
trace events related to the program when it is determined that the program should be monitored; and
determine a number of events to be traced before the trace is concluded; and
analyze the results of the traced events to determining if the process includes malware.

10. The apparatus of claim 9, wherein the number of events to be traced is related to the type of program.

11. The apparatus of claim 9, wherein the detection module is further configured to:
determine if the program has a child program.

12. The apparatus of claim 11, wherein the detection module is further configured to:
determine a number of child events to be traced if the program has the child program.

13. The apparatus of claim 12, wherein the detection module is further configured to:
combine the traced child events with the events traced.

14. The apparatus of claim 9, wherein the number of events to be traced is based on contextual triggers.

15. The apparatus of claim 9, wherein the results of the trace are communicated to a network element for further analysis.

16. A method comprising:
determining that a program related to a process has begun to run;
tracing events related to the program when it is determined that the program should be monitored;
determining a number of events to be traced before the trace is concluded; and
analyzing the results of the traced events to determining if the process includes malware.

17. The method of claim 16, wherein the number of events to be traced is related to the type of program.

18. The method of claim 16, further comprising:
determining if the program has a child program.

19. The method of claim 18, further comprising:
determining a number of child events to be traced if the program has the child program.

20. The method of claim 19, further comprising:
combining the traced child events with the events traced.

21. The method of claim 16, further comprising:
analyzing the results of the traced events; and
sending the results to a security server.

22. The method of claim 16, wherein the number of events to be traced is based on contextual triggers.

23. A system for the tracing and detection of malware, the system comprising:
a detection module configured to:
determine that a program related to a process begins to run;
trace events related to the program when it is determined that the program should be monitored;
determine a number of events to be traced before the trace is concluded, wherein the number of events to be traced is related to the type of program;
combine the traced events with events from other programs related to the process; and
analyze the results of the combined traced events and the events from other programs to determining if the process includes malware.

24. The system of claim 23, wherein the number of events to be traced is based on contextual triggers.

25. The system of claim 23, wherein the detection module is further configured to:
determine if the program has a child program;
determine a number of child events to be traced if the program has a child program; and
combine the traced child events with the events traced.
